(19) United States
(12) Patent Application Publication
(10) Pub. No.: US 2025/0257789 A1
(43) Pub. Date: Aug. 14, 2025

(54) A COOLING DEVICE HAVING A CONDUIT ARRANGEMENT

(71) Applicant: BSH Hausgeräte GmbH, München (DE)

(72) Inventors: Zeki Demirhan Kusakci, Tekirdag (TR); Serkan Dönderici, Istanbul (TR)

(21) Appl. No.: 18/701,286

(22) PCT Filed: Nov. 29, 2022
(86) PCT No.: PCT/EP2022/083566

§ 371 Date: Apr. 15, 2024

(30) Foreign Application Priority Data
Nov. 30, 2021 (TR) 2021/018742

(51) Int. Cl. F16G 13/16; E05D 11/00; F16G 13/07

(52) U.S. Cl. CPC F16G 13/16; E05D 11/0081; F16G 13/07; E05Y 2900/31

(57) ABSTRACT

A cooling device contains a cabinet, a door pivotably coupled to the cabinet and movable between a closed position for closing the cabinet and an open position for allowing access to the cabinet, a hinge assembly for moving the door between the open position and the closed position, and a conduit arrangement provided on the hinge assembly for conducting a flexible conduit from the cabinet to the door. The conduit arrangement is configured to be movable between a serpentine position in which the conduit arrangement is folded on the hinge assembly when the door is at the closed position and an elongated position in which the conduit arrangement extends from the cabinet to the door when the door is at the open position.

### TECHNICAL FIELD OF THE INVENTION

The present invention relates to a cooling device according to the preamble of claim 1.

### BACKGROUND OF THE INVENTION

In numerous cooling devices, such as refrigerators and freezers, it is frequently necessary to use displays in the door. To supply such displays with power or data, it is required to lay one or more conduits from the cabinet of the cooling devices into the door. In addition, the conduits which are laid from the cabinet into the door may transfer the liquid or gas in order to supply needs to the mechanism provided on the door such as ice maker. When the door moves between an open position and a closed position, the conduit may damage and there may be fatigue fractures on the conduit.

A prior art publication in the technical field of the invention may be referred to as U.S. Pat. No. 11,091,943 (B2), which discloses a hinge assembly for a refrigerating appliance includes a door engaging member that is configured to attach to a door panel through an operational path of the door engaging member. A cabinet engaging member is configured to attach to a structural cabinet. An articulating mechanism extending between the door engaging member and the cabinet engaging member. The articulating mechanism partially defines the operational path of the door engaging member. An articulating wire chase that is coupled to the cabinet engaging member and slidably coupled to the articulating mechanism at a guide slot. The articulating mechanism is operable between a collapsed position and an extended position. Operation of the articulating mechanism operates the articulating wire chase between a serpentine position and an elongated position.

### SUMMARY OF THE INVENTION

An object of the present invention is to provide a cooling device having an arrangement for guiding the conduit in order to prevent the conduit from damaging when the door is moved between the closed position and the open position.

The present invention proposes a cooling device comprising a cabinet, a door pivotably coupled to the cabinet and movable between a closed position for at least partly closing the cabinet and an open position for allowing access to the cabinet a hinge assembly for moving the door between the open position and the closed position, a conduit arrangement provided on the hinge assembly for conducting a flexible conduit from the cabinet to the door, wherein the conduit arrangement is configured to be movable between a serpentine position in which the conduit arrangement is folded on the hinge assembly when the door is at the closed position and an elongated position in which the conduit arrangement extends from the cabinet to the door when the door is at the open position. The conduit arrangement further comprises a chain structure having a plurality of chain links arranged in a sequentially manner in such a way that the conduit is passing through the chain links and is taking in shape harmoniously with the chain structure with respect to the movement of the hinge assembly. Thus, the conduit inside the conduit arrangement is prevented from being damaged from external forces. Besides, the length of the conduit arrangement in the depth direction and the width direction of the cabinet is decreased when the door is at the closed position.

The first type chain link is configured to have a restricted rotation in a first rotation direction in order for the conduit arrangement to fold in the form of essentially U-shaped when a plurality of the first type chain links is connected to each other. Thus, the length of the chain structure comprising the first type chain links in depth direction of the cabinet is decreased. When the plurality of first type chain links is connected to each other, the chain structure which consists of first type chain links extends in the form of U-shaped when the conduit arrangement is at the serpentine position.

The conduit arrangement comprises one or more second type chain links having a second rotation limiting member configured to have a restricted rotation in a second rotation direction which is opposite to the first rotation direction and one or more second type chain links are provided between two first type chain links in order for the conduit arrangement to fold in a way for the conduit arrangement to have the serpentine position when the door is at the closed position. Thus, the length of the conduit arrangement in the depth direction and the width direction is decreased. The second rotation limiting member may be a rod or a projected part formed on the second type chain link. The second rotation limiting member may be provided on the side edge of the second type chain link in order to limit the rotation of the second type chain link in the second direction.

In another embodiment of the present invention, the conduit arrangement and chain structure are being in a shape having two essentially U-shaped regions, when the door is at the closed position. At least one second type chain link is provided between two first type chain links and another second type chain link is provided between another two first type chain links. Therefore, the conduit arrangement is folded so as to have three saddle point in order to decrease the length of the conduit arrangement in the depth direction of the cabinet.

The first type chain link and the second type chain link have a link body provided with a connection recess and a connection protrusion, wherein the connection protrusion and the connection recess are sized and shaped to each other for connecting the link bodies to each other. Thus, connecting the link bodies to each other is simplified for the user. The link bodies are engaged with each other rotatably. The link bodies are removably connected to each other.

The first type chain link comprises a first rotation limiting member configured to limit rotation of the first type chain link in the first rotation direction. Thus, the rotation of the first type chain link in the first rotation direction which is opposite to the second rotation direction is limited. The only difference between the link bodies of the first type chain link and the second type chain link is location of the rotation limiting members. For instance, the first rotation limiting member is provided in the vicinity of the left side wall of the link body, the second rotation limiting member is provided in the vicinity of the right side wall of the link body.

In another embodiment of the present invention, the conduit arrangement is connected to the cabinet from the chain structure by means of a cabinet connecting member having a link connection portion for connecting to the link body. Thus, connecting the chain structure to the cabinet is provided securely.

The link connection portion has at least one of a first engaging opening and a first engaging projection for connecting to the link body. Since the link body has at least one of the connection protrusions and the connection recess, connecting the link body to the link connection portion is simplified. In an embodiment of the present invention, the link connection portion has the first engaging opening. The connection protrusion of the link body is inserted into the first engaging opening in order to connect the link body to the link connection portion.

In another embodiment of the present invention, the link connection portion is provided with a slit for the conduit to be passed through. Thus, the inserting conduit inside the link connection portion or removing the conduit from the link connection portion is provided without removing the cabinet connecting member from the cabinet.

In another embodiment of the present invention, the cabinet connecting member has a fixing portion adjacent to the link connection portion for connecting to the cabinet.

Therefore, the chain structure is connected to the cabinet, since the link body is connected to the link connection portion and the fixing portion is connected to the cabinet.

The fixing portion has a screw hole for screwing the fixing portion on the cabinet. Thus, the fixing of the fixing portion on the cabinet is simplified.

In another embodiment of the present invention, the fixing portion has a cover. Thus, the mechanical fastening element used for fixing the fixing portion on the cabinet is hidden by the cover. The cover, covers the front surface of the cabinet connecting member facing the door when the door is at the closed position.

The fixing portion has at least one holding element for holding the cover on the fixing portion. Thus, the cover is removably mounted on the front surface of the fixing portion.

In another embodiment of the present invention, the conduit arrangement is connected to the door by means of a door connecting member having at least one of a second engaging projection or a second engaging opening for connecting to the link body. Thus, the conduit arrangement is connected to the door without using any mechanical fastening element. In another embodiment of the present invention, the door connecting member has a second engaging projection. The second engaging projection is inserted into the connection recess of the link body in order to connect the link body to the door.

The hinge assembly comprises a cabinet engaging element attached in use to the cabinet, a door engaging element attached in use to the door and a jointed member extending between the cabinet engaging element and the door engaging element. Thus, rotating ability of the hinge assembly is improved.

The jointed member is movable between a collapsed position in which the jointed member extends in a parallel way to a width direction of the cabinet when the door is at the closed position and an extended position in which the jointed member extending from the cabinet to the door when the door is at the open position. Thus, the door is moved between the open position and the closed position smoothly.

In this document, “X-direction” corresponds to a width direction of the cooling device and the cabinet.

In this document, “Y-direction” corresponds to a depth direction of the cooling device and the cabinet.

In this document, “Z-direction” corresponds to a length direction of the cooling device and the cabinet.

### BRIEF DESCRIPTION OF THE FIGURES

The accompanying drawings are given solely for the purpose of exemplifying the invention whose advantages over prior art were outlined above and will be explained in detail hereinafter:

FIG. 1 is a perspective view of the cooling device when the door is at the open position and the conduit arrangement is at the elongated position according to the present invention.

FIG. 2 is another perspective view of the cooling device when the door is at the open position and the conduit arrangement is at the elongated position according to the present invention.

FIG. 3 is a perspective view of the conduit arrangement provided on the hinge assembly when the conduit arrangement is at the serpentine position according to the present invention.

FIG. 4 is a perspective view of the conduit arrangement provided on the hinge assembly when the conduit arrangement is at the elongated position according to the present invention.

FIG. 5 is a perspective view of the conduit arrangement provided with the door engaging member and cabinet engaging member when the conduit arrangement is at the serpentine position according to the present invention.

FIG. 6 is a perspective view of the conduit arrangement provided with the door engaging member and cabinet engaging member when the conduit arrangement is at the elongated position according to the present invention.

FIG. 7 is a perspective view of the link body according to the present invention.

FIG. 8 is a perspective view of the cabinet engaging member according to the present invention.

FIG. 9 is a perspective view of the door engaging member according to the present invention.

### DETAILED DESCRIPTION OF THE FIGURES

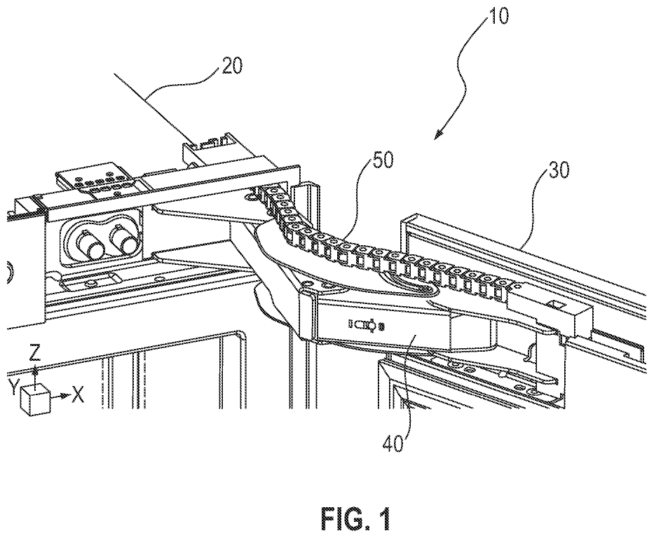

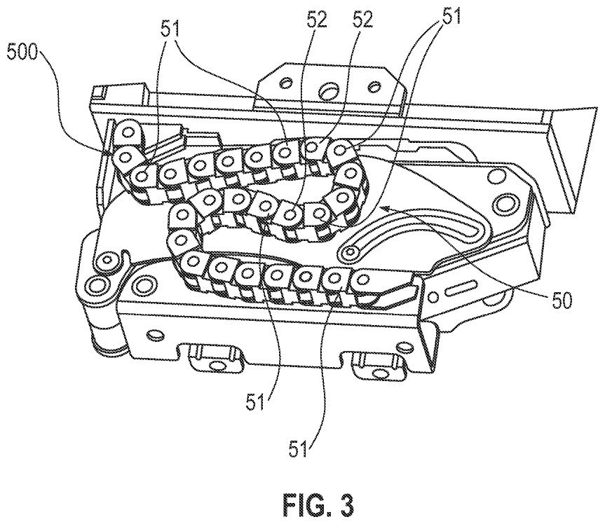

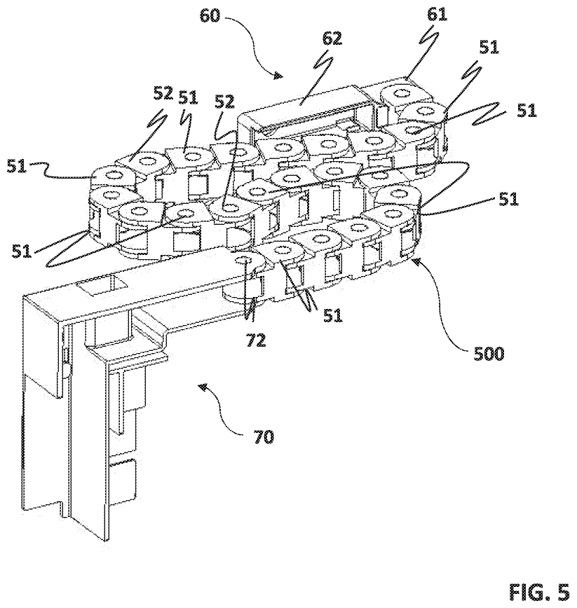

The present invention proposes a cooling device (10) comprising a cabinet (20). A door (30) is pivotably coupled to the cabinet (20). Said door (30) movable between a closed position for at least partly closing the cabinet (20) and an open position for allowing access to the cabinet (20). In FIG. 1, the door is at the open position. The cooling device (10) comprises a hinge assembly (40) for moving the door (30) between the open position and the closed position. A conduit arrangement (50) is provided on the hinge assembly (40) for conducting a flexible conduit such as a cable, from the cabinet (20) to the door (30), wherein the conduit arrangement (50) is configured to be movable between a serpentine position in which the conduit arrangement (50) is folded on the hinge assembly (40) when the door (30) is closed position and an elongated position in which the conduit arrangement (50) extends from the cabinet (20) to the door (30) when the door (30) is at the open position. Referring to FIGS. 1,2,4 and 6 the conduit arrangement (50) is at the elongated position. Referring to FIGS. 3 and 5, the conduit arrangement (50) is at the serpentine position. The conduit arrangement (50) further comprises a chain structure (500) having a plurality of chain links (51, 52) arranged in a sequentially manner in such a way that the conduit is passing through the chain links (51,52) and is taking in shape harmoniously with the chain structure (500) with respect to the movement of the hinge assembly (40). The chain structure (500) comprises a plurality of first type chain link (51) and at least one second type chain link (52). The first type chain links (51) and the second type chain link (52) are arranged in a sequentially manner in such a way that the chain structure (500) is taking in shape harmoniously. The conduit arrangement (50) takes in shape harmoniously thanks to the chain structure (500).

The conduit arrangement (50) comprises a plurality of first type chain links (51) configured to have a restricted rotation in a first rotation direction in order for the conduit arrangement (50) to fold in the form of essentially U-shaped when a plurality of the first type chain links (51) are connected to each other. When the chain structure (500) consists of a plurality of the first type chain links (51), the chain structure (500) extends in the form of U-shaped.

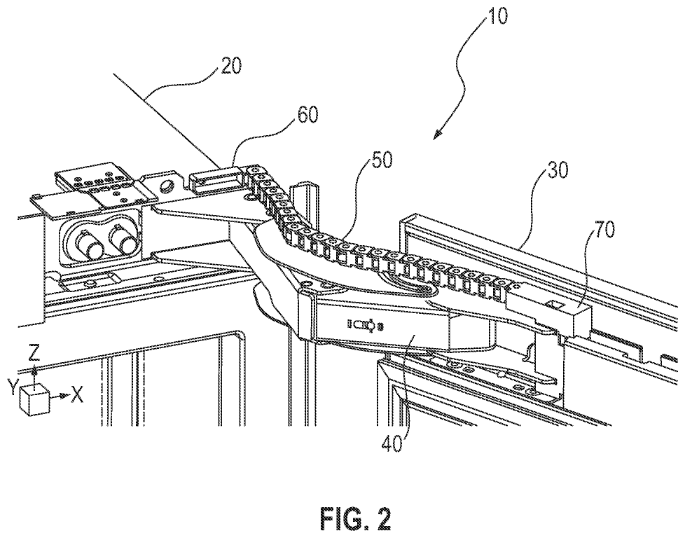

The conduit arrangement (50) comprises one or more second type chain links (52) having a second rotation limiting member configured to have a restricted rotation in a second rotation direction which is opposite to the first rotation direction and one or more second type chain links (52) are provided between two first type chain links (51) in order for the conduit arrangement (50) to fold in a way for the conduit arrangement (50) to have the serpentine position when the door (30) is at the closed position. At least one second type chain link (52) is provided between two first type chain links (51) in order for the conduit arrangement (50) and chain structure (500) to fold in a way for the conduit arrangement (50) to have a serpentine position when the door (30) is at the closed position. When the chain structure (500) consists of a plurality of the first type chain links (51), the chain structure (500) extends in the form of U-shaped. Referring to FIG. 3, a first group consisting of a plurality of the first type chain links (51) is connected to the cabinet (20) from the first type chain link (51) which is provided at the one end of the first group. A second type chain link (52) is connected to the first type chain link (51) which is provided at the other end of the first group. A second group consisting of a plurality of the first type chain links (51) is connected to the second type chain link (52). The second group extends in the form of reverse U-shaped while the first group extends in the form of U-shaped. Since one second type chain link (52) is provided between the first group and second group which consists of a plurality of the first type chain link (51), the conduit arrangement (50) is moved to the serpentine position when the door (30) is moved to the closed position. Referring to FIGS. 1 and 2, when the conduit arrangement (50) is at the elongated position, the first group and the second group extend from the cabinet (20) to the door (30) at an angle with respect to each other since the second type chain link (52) is provided between the first group and the second group. Thus, the length of the conduit arrangement (50) in a depth direction (Y) of the cabinet (20) is decreased.

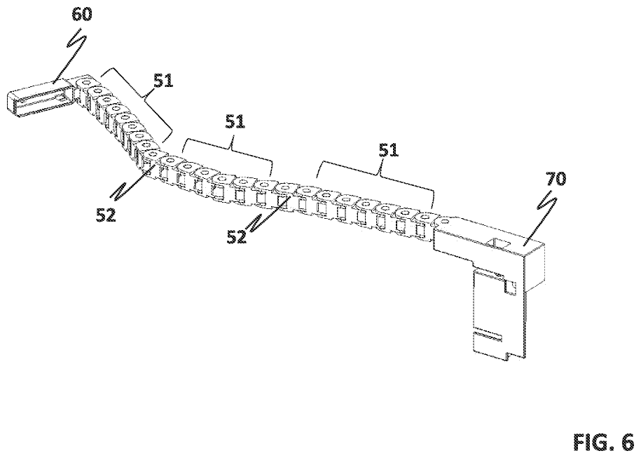

Referring to FIGS. 5 and 6, the conduit arrangement (50) and chain structure (500) are being in a shape having two essentially U-shaped regions, when the door (30) is at the closed position. At least one second type chain link (52) is placed between two first type chain links (51) and another second type chain link (52) is placed between another two first type chain links (51). According to this embodiment, the chain structure (500) comprises the first group consisting of a plurality of first type chain links (51); the second group consisting of a plurality of first type chain links (51), which is connected to the first group via a second type chain link (52); a third group consisting of a plurality of first type chain links (51) which is connected to the second group via a second type chain link (52). Therefore, the first group extends in the form of U-shaped; the second group extends in the form of reverse U-shaped and the third group extends in the form of the U-shaped, when the door (30) is at the closed position. Thus, the conduit arrangement (50) is moved to the serpentine position when the door (30) is at the closed position.

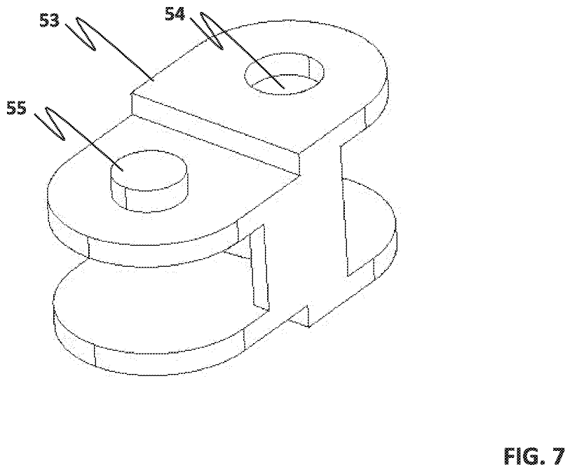

Referring to FIG. 7, the first type chain link (51) and the second type chain link (52) have a link body (53) provided with a connection recess (54) and a connection protrusion (55) The connection protrusion (55) and the connection recess (54) are sized and shaped to each other for connecting the link bodies (53) to each other. The link body (53) is almost the same for the first type chain link (51) and the second type chain link (52). The link bodies (53) connect each other by engaging the connection protrusion (55) into the connection recess (54). For instance, when the technician wants to connect the first type chain link (51) and the second type chain link (52), the connection protrusion (55) of the first type chain link (51) is engaged with the connection recess (54) of the second type chain link (52) by the technician. When someone, for example technicians wants to separate the first type chain link (51) and the second type chain link (52), the connection protrusion (55) of the first type chain link (51) is disengaged from the connection recess (54) of the second type chain link (52) by the technicians.

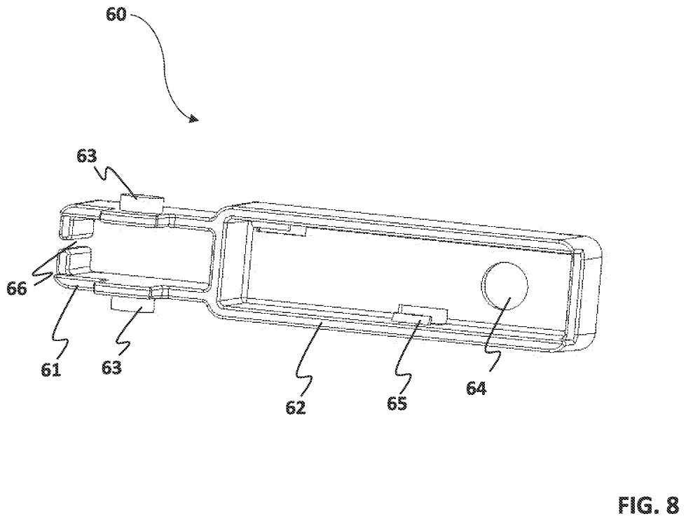

Referring to FIGS. 2 and 8, the conduit arrangement (50) is connected to the cabinet (20) by means of a cabinet connecting member (60) having a link connection portion (61) for connecting to the link body (53). As seen in FIG. 8, the link connection portion (61) has a similar shape as the link body (53). The link connection portion (61) has at least one of a first engaging opening and a first engaging projection (63) for connecting to the link body (53). According to the one embodiment of the present invention, the first engaging projection (63) is inserted into the connection recess (54) of the link body (53) in order to connect the link body (53) and the cabinet connecting member (60).

Referring to FIG. 8, the link connection portion (61) is provided with a slit (66) for the conduit to be passed through. The slit (66) extends along the side wall of the link connection portion (61) which is adjacent to the outside of the cabinet connecting member (60). Thus, the conduit can be removed from the inside of the link connection portion (61) without removing the cabinet connecting member (60) from the cabinet (20).

Referring to FIG. 8, the cabinet connecting member (60) has a fixing portion (62) adjacent to the link connection portion (61) for connecting to the cabinet (20). The cabinet connecting member (60) is fixed from the fixing portion (62). The link body (53) is connected to the link connection portion (61). The cabinet connecting member (60) is fixed to the cabinet (20) from the fixing portion (62). Therefore, the conduit arrangement (50) is connected to the cabinet (20).

The fixing portion (62) has a screw hole (64) for screwing the fixing portion (62) on the cabinet (20). A screw or any mechanical fastening element is passed through the screw hole (64). Therefore, the fixing the cabinet connecting member (60) on the cabinet (20) is simplified.

Referring to FIG. 8, the fixing portion (62) has at least one holding element (65) for holding the cover on the fixing portion (62). In order to fix the cover on the fixing portion (62), the cover is mounted on the holding element (65) in a removable manner.

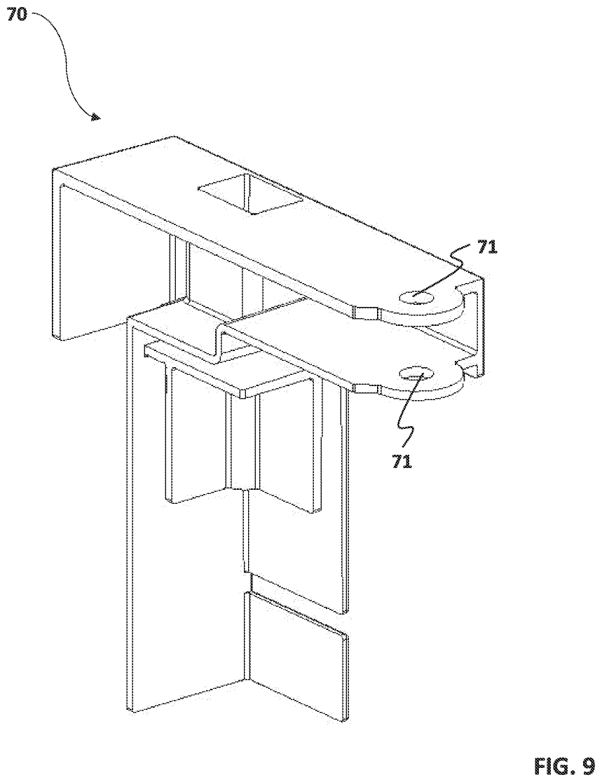

Referring to FIGS. 2 and 9, the conduit arrangement (50) is connected to the door (30) by means of a door connecting member (70) having at least one of a second engaging projection (72) or a second engaging opening (71) for connecting to the link body (53). The second engaging projection (72) is inserted into the connection recess (54) of the link body (53) in order to connect the link body (53) to the door connecting member (70).

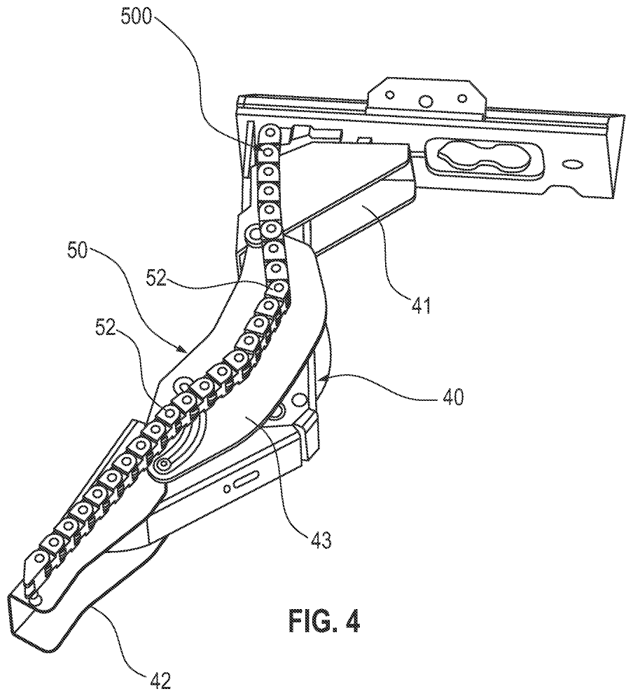

Referring to FIG. 4, the hinge assembly (40) comprises a cabinet engaging element (41) attached in use to the cabinet (20), a door engaging element (42) attached in use to the door (30) and a jointed member (43) extending between the cabinet engaging element (41) and the door engaging element (42). The cabinet engaging element (41) is configured to attach to the cabinet (20). The jointed member (43) is rotatably connected to the cabinet engaging element (41). The door engaging element (42) is rotatably connected to the jointed member (43). The conduit arrangement (50) is rotationally coupled to the hinge assembly (40).

The jointed member (43) is movable between a collapsed position in which the jointed member (43) extends in a parallel way to a width direction (X) of the cabinet (20) when the door (30) is at the closed position and an extended position in which the jointed member (43) extending from the cabinet (20) to the door (30) when the door (30) is at the open position. As seen in FIG. 3, the jointed member (43) is at the collapsed position. As seen in FIG. 4, the jointed member (43) is at the extended position. The hinge assembly (40) can be rotated between an angle 0° and 115° with respect to the width direction (X) of the cabinet (20). The jointed member (43) extends from the cabinet (20) to the door (30) in a parallel way to a depth direction (Y) of the cabinet (20) when the hinge assembly (40) rotated 90° with respect to the width direction (X) of the cabinet (20). In this document, “Z-direction” corresponds to a length direction (Z) of the cooling device and the cabinet.

### REFERENCE LIST

10. Cooling device
20. Cabinet
30. Door
40. Hinge assembly
   41. Cabinet engaging element
   42. Door engaging element
   43. Jointed member
50. Conduit arrangement
   500. Chain structure
   51. First type chain link
   52. Second type chain link
   53. Link body
   54. Connection recess
   55. Connection protrusion
60. Cabinet connecting member
   61. Link connection portion
   62. Fixing portion
   63. First engaging projection
   64. Screw hole
   65. Holding element
   66. Slit
70. Door connecting member
   71. Second engaging opening
   72. Second engaging projection
X. Width direction
Y. Depth direction
Z. Length direction

1-14. (canceled)

15. A cooling device, comprising:
a cabinet;
a door pivotably coupled to said cabinet and movable between a closed position for at least partly closing said cabinet and an open position for allowing access to said cabinet;
a hinge assembly for moving said door between the open position and the closed position; and
a conduit configuration disposed on said hinge assembly and conducting a flexible conduit from said cabinet to said door, wherein said conduit configuration is configured to be movable between a serpentine position in which said conduit configuration is folded on said hinge assembly when said door is at the closed position and an elongated position in which said conduit configuration extends from said cabinet to said door when said door is at the open position, said conduit configuration further contains a chain structure having a plurality of chain links disposed in a sequential manner such that said flexible conduit is passing through said chain links and is taking a shape harmoniously with said chain structure with respect to a movement of said hinge assembly.

16. The cooling device according to claim 15, wherein said chain links include a first type chain link configured to have a restricted rotation in a first rotation direction in order for said conduit configuration to fold in a form of a general U-shape when a plurality of first type chain links is connected to each other.

17. The cooling device according to claim 16, wherein said conduit configuration contains at least one second type chain link having a second rotation limiting member configured to have a restricted rotation in a second rotation direction which is opposite to the first rotation direction and at least one of said second type of chain link is provided between two of said first type chain links in order for said conduit configuration to fold in a way for said conduit configuration to have the serpentine position when said door is in the closed position.

18. The cooling device according to claim 15, wherein said conduit configuration and said chain structure are in a shape having two generally U-shaped regions, when said door is at the closed position.

19. The cooling device according to claim 16, wherein each of said first type chain links contains a first rotation limiting member configured to limit rotation of said first type chain links in the first rotation direction.

20. The cooling device according to claim 17, wherein both of said first type chain links and said second type chain links have a link body with a connection recess formed therein and a connection protrusion, wherein said connection protrusion and said connection recess are sized and shaped to each other for connecting link bodies to each other.

21. The cooling device according to claim 20, further comprising a cabinet connecting member having a link connection portion, said conduit configuration is connected to said cabinet by means of said cabinet connecting member having said link connection portion in order to be connected to said link body.

22. The cooling device according to claim 21, wherein said link connection portion has at least one of a first engaging opening formed therein and a first engaging projection for connecting to said link body.

23. The cooling device according to claim 21, wherein said link connection portion has a slit formed therein for said flexible conduit to be passed through.

24. The cooling device according to claim 21, wherein said cabinet connecting member has a fixing portion adjacent to said link connection portion for connecting to said cabinet.

25. The cooling device according to claim 24, wherein said fixing portion has a screw hole formed therein for screwing said fixing portion on said cabinet.

26. The cooling device according to claim 20, further comprising a connecting member having at least one of a second engaging opening formed therein for connecting to said link body, said conduit configuration is connected to said door by means of said door connecting member.

27. The cooling device according to claim 15, wherein said hinge assembly contains a cabinet engaging element attached in use to said cabinet, a door engaging element attached in use to said door and a jointed member extending between said cabinet engaging element and said door engaging element.

28. The cooling device according to claim 27, wherein said jointed member is movable between a collapsed position in which said jointed member extends in a parallel way to a width direction of said cabinet when said door is at the closed position and an extended position in which said jointed member extending from said cabinet to said door when said door is at the open position.
